(19) United States
(12) Patent Application Publication
(10) Pub. No.: US 2025/0108884 A1
(43) Pub. Date: Apr. 3, 2025

(54) Electrically-Assisted Pedal Cycles

(71) Applicant: EBIKE SYSTEMS LTD, London (GB)

(72) Inventors: John Keech, London (GB); Riccardo Meldolesi, Hove (GB)

(21) Appl. No.: 18/844,749

(22) PCT Filed: Mar. 7, 2023
(86) PCT No.: PCT/GB2023/050524

§ 371 Date: Sep. 6, 2024

(30) Foreign Application Priority Data
Mar. 7, 2022 (GB) 2203112.4
Mar. 24, 2022 (GB) 2204131.3

(51) Int. Cl. B62M 6/55; B62M 6/45; B62M 11/18

(52) U.S. Cl. CPC B62M 6/55; B62M 6/45; B62M 11/18

(57) ABSTRACT

An electrically-assisted pedal cycle has a drive system with an input that receives drive from a pedal of the cycle and rotates about an axis; an output that rotates about that axis to provide drive to a cycle wheel; an electric motor that provides motor drive to the output; and a drive train that receives drive from the electric motor and the pedal and transmits drive to the output. Between cycle speeds of V1 and V2, where V2 is greater than V1, the drive train provides a continually variable transmission (CVT) by which the pedal cadence is controlled by the electric motor. Above a cycle speed of V2, the drive train disengages drive from the electric motor to provide output drive only from the pedal.

### CROSS-REFERENCE TO RELATED APPLICATIONS

This is the U.S. National Stage application of International Application No. PCT/GB2023/050524, filed Mar. 7, 2023, which claims the benefit of priority from GB 2203112.4, filed Mar. 7, 2022 and GB 2204131.3, filed Mar. 24, 2022. The entire contents of these priority applications are incorporated by reference.

### FIELD

The present invention relates to electrically-assisted pedal cycles.

### BACKGROUND

There are various forms of pedal cycle. One conventional form of pedal cycle is that which is only ever driven by a cyclist applying force to the pedals, such cycles sometimes being referred to as “push bikes”. Another more recent form of pedal cycle is the electrically-assisted pedal cycle, commonly now known as an “e-Bike”, in which electrical power is used to assist or replace the efforts of the rider. Both conventional pedal cycles and e-Bikes may have two, three or four wheels, and, in some, cases even more. In the present document, the term “pedal cycle” is used to include both conventional pedal cycles and e-Bikes.

As mentioned, in an e-Bike, electrical power is used to assist, or in some cases replace, the efforts of the rider. Accordingly, e-Bikes include means for storing electrical energy, such as batteries, and an electric motor arranged to propel, either in combination with pedal input, or to replace pedal input. The batteries can be recharged by plugging them into a supply of electrical energy, such as an outlet from a mains supply; in some cases, also by recovering energy from motion of the cycle by way of regenerative braking, and in others by generation of electricity in a series hybrid configuration. The principle of regenerative braking will be familiar to those skilled in this field of technology.

e-Bikes may be placed generally into one of two groups. The first group is that in which the cycle can provide electrical assistance on demand, at any time, regardless of whether or not the cyclist is pedalling. Cycles in this group can be thought of as being generally equivalent to electric mopeds. The pedal input may be rarely used or only as a “limp home” capability when the battery is discharged. Cycles in the second group only provide electrical assistance when the cyclist is pedalling. These are referred to as “pedelecs”.

Currently, in many countries, including the UK, pedelecs are effectively legally classified as conventional bicycles and so may be ridden without a driving license or insurance, providing electrical assistance ceases at a speed of 25 kph (although a separate category of “speed pedelecs” with a speed limitation of 45 kph has license and insurance requirements). There are therefore few barriers to owning and operating a pedelec.

In recent years, technical advances have been made to the electro-mechanical drive arrangements and to the associated energy storage and recovery devices used in e-Bikes. These advances have resulted in e-Bikes that can be operated with greater efficiency, and hence greater ease, by the cyclist.

For all the reasons given above, e-Bikes are becoming increasingly popular, all over the world.

By way of background, the reader is referred to our PCT publications WO2010/092345, WO2017/021715 and WO2018/020259, where much information about e-Bikes is provided. There is particular reference to the use of continuously variable transmissions (CVTs) in pedelecs.

The use of CVTs in pedelecs is recent and is characterized by significant ease-of-use advantages. Nonetheless, given the earlier adoption of direct drive systems in pedelecs, the riding feeling of a CVT requires to be adapted to make it behave and feel similar to a direct drive, which has become the norm. This involves modifying the mechanical configuration of the CVT to provide additional boost capability at launch and in high torque requirement situations. The question then arises as to how that extra electrical assistance is switched in and out in a controlled and smooth manner.

### BRIEF SUMMARY

An aspect of using CVT systems is that, in territories where there is a maximum speed limit for electrical assistance-25 kph in many countries-a rider may wish to increase speed above this limit, which would have to be done without electrical assistance. Therefore, there is a need to be able to switch over from electrical assistance to manual pedalling for higher speeds, and back again, in a controlled and smooth manner.

Preferred embodiments of the present invention aim to provide pedelecs and drive systems for them, which seek to meet the above requirements. Embodiments of the invention may be particularly effective in the use of a 3-branch power combining epicyclic transmission (two inputs and one output) in a CVT transmission.

According to one aspect of the present invention, there is provided a drive system for an electrically-assisted pedal cycle, the system comprising:
an input that, in use, receives drive from a pedal of the cycle and rotates about an axis;
an output that, in use, rotates about said axis to provide drive to a driven wheel of the cycle;
an electrical machine that, in use, provides motor drive to said output; and
a drive train that, in use, receives drive from the electrical machine and the pedal and transmits drive to said output:
wherein:
between cycle speeds of V1 and V2, where V2 is greater than V1, the drive train provides a continually variable transmission (CVT) by which the pedal cadence is controlled by the electrical machine; and
above a cycle speed of V2, the drive train disengages drive from the electrical machine to provide output drive only from said pedal.

Preferably, V1>0 and, between cycle speeds of 0 and V1, the drive train provides output drive only from said pedal.

Preferably, above a cycle speed of V2, the drive train provides a gear ratio that is higher than that provided below a cycle speed of V1.

Preferably, the drive train comprises an epicyclic gear set having a first input connected to the electrical machine and a second input connected to the pedal.

Preferably, the epicyclic gear set is a dual epicyclic gear set having first and second stages that are interconnected, the first stage comprising a first sun, planets and annulus and the second stage comprising a second sun, planets and annulus.

Preferably, the electrical machine has a rotor connected to drive the first sun.

Preferably, drive from the pedal is connected to drive the second planet carrier.

Preferably, the first annulus is connected to rotate with said output.

Preferably, the second sun is connected to rotate with said output.

Preferably, the second annulus is connected to rotate with the first planet carrier.

Preferably, a first, one-way clutch is connected between the pedal input and said output, to prevent the pedal input from rotating faster than said output.

Preferably, a second clutch is connected between a moveable part of the drive train and a fixed part of the drive system or respective cycle, and an actuator for the second clutch activates the clutch to operate in a one-way mode.

Preferably, said actuator responds to the angular speed of said output.

Preferably, said actuator is electrically operated.

Preferably, said actuator is selectively operable to cause the second clutch to lock the second planet carrier to said fixed part.

Preferably, said moveable part of the drive train is the second annulus.

Preferably, a third, one-way clutch is connected between the electrical machine and the drive train.

Preferably, V1=5 kph.

Preferably, V2=25 kph.

The invention extends to an electrically-assisted pedal cycle having a drive system according to any of the preceding aspects of the invention.

The electrically-assisted pedal cycle may be a pedelec in which electrical assistance is provided only when the cyclist is pedalling.

Alternatively, electrical assistance may be available both when the cyclist is pedalling and also when the cyclist is not pedalling.

In such a case, the electrically-assisted pedal cycle may have a throttle control by which a cyclist can apply or superimpose a desired amount of electrical assistance.

The drive train may be located within a hub of the driven wheel. Alternatively, the drive train may be located around or adjacent a crankshaft connecting two pedal cranks.

The driven wheel may be a rear wheel or a front wheel.

The invention extends to a method of operating an electrically-assisted pedal cycle according to any of the above aspects of the invention, comprising the steps of providing motor drive to the driven wheel of the cycle by said electrical machine and providing pedal drive to the driven wheel of the cycle, via said drive train.

In the context of this specification, the term ‘pedelec’ means an electrically-assisted pedal cycle in which electrical assistance is provided only when the cyclist is pedalling.

### BRIEF DESCRIPTION OF THE DRAWINGS

For a better understanding of the invention, and to show how embodiments of the same may be carried into effect, reference will now be made, by way of example, to the accompanying diagrammatic drawings, in which:

FIG. 1 is a side view of a pedelec;

FIG. 2 is a diagrammatic view of a drive system for the pedelec;

FIG. 3 is a graph to show pedal cadence (RPM) against pedelec (bike) speed;

FIG. 4 is a graph to show angular speed (RPM) against pedelec (bike) speed, for the ring gear of an epicyclic gear set;

FIG. 5 a graph to show angular speed (RPM) against pedelec (bike) speed, for an electric drive motor driving a sun gear of an epicyclic gear set;

FIG. 6 shows one example of one-way clutch in both an activated (enabled) state and a deactivated (disabled) state; and

FIG. 7 is a view similar to FIG. 2, but showing a mid-drive configuration.

In the figures, like references denote like or corresponding parts.

### DETAILED DESCRIPTION

It is to be understood that the various features that are described in the following and/or illustrated in the drawings are preferred but not essential. Combinations of features described and/or illustrated are not considered to be the only possible combinations. Unless stated to the contrary, individual features may be omitted, varied or combined in different combinations, where practical.

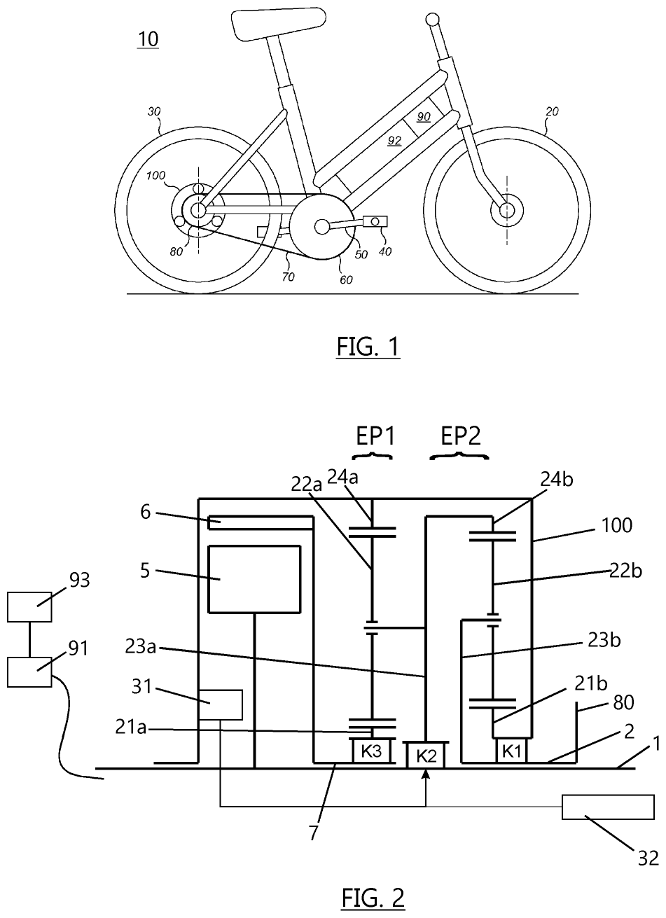

FIG. 1 shows a pedelec in the form of a bicycle 10. The bicycle 10 is similar to a conventional bicycle in having a steerable wheel 20 at the front and a driveable wheel 30 at the back. The bicycle 10 also has a conventional arrangement of pedals 40 on crank arms 50 that drive a front toothed cog 60 connected by a chain or toothed belt 70 to a rear sprocket 80, the rear sprocket being mounted co-axially with the rear wheel 30. However, the bicycle 10 differs from a conventional bicycle in that the rear sprocket 80 is not fixedly mounted to a hub 100 of the rear wheel 30 to drive that wheel directly. Instead, the rear sprocket 80 provides a rider's power input to a drive system that is disposed within the hub 100. A control housing 90 and a battery housing 92 are fitted to the frame of the bicycle 10.

A drive system is mounted within the hub 100 and is described as follows, with reference to FIG. 2. The drive system provides a drive train that receives drive from an electrical machine and the pedals 40 and transmits drive to an output. For ease of explanation, the hub 100 is referred to in the following as an outer hub 100 and provides the output of the drive system. The outer hub 100 is typically connected to the outer part of the rear wheel 30 by spokes, or by any other connection, to provide drive to the rear wheel 30.

It will be noted that, for ease of explanation, the diagrammatic view of FIG. 2 shows just an upper part of the drive system with multiple planets, arranged around the axis of a central axle 1 fixed to the bike frame.

As mentioned above, the sprocket 80 is not connected directly to the outer hub 100, as would be the case with a regular bicycle. Instead, it is connected to an inner hub 2 that is mounted on bearings (not shown) for rotation about fixed axle 1, which is secured to the bicycle frame. The sprocket 80 preferably incorporates a freewheel mechanism, as found on many regular bicycles. The outer hub 100 is of generally cylindrical shape and is mounted at a first end on the inner hub 2, via a one-way clutch K1. An opposite end of the outer hub 100 is mounted on the axle 1 by way of one or more bearings. The outer hub 100 and the inner hub 2 are rotatable about a common axis, which is the axis of the axle 1. The one-way clutch K1 could be made up of a bearing and a separate clutch.

An electrical machine comprises a stator 5 that is fixedly mounted on the axle 1 and a rotor 6 that is mounted on a shaft 7 that is mounted on suitable bearings (not shown) for rotation about the axle 1. A first stage EP1 of a dual epicyclic gear set EP1, EP2 connects the shaft 7 to the outer hub 100. The axle 1 is hollow and receives cables to connect a controller 91 (and a battery 93) to components of the drive system.

The dual epicyclic gear set EP1, EP2 affords a high gear ratio and a small packaging space for a given torque capacity. The first epicyclic stage EP1 comprises first sun 21a, planets 22a, planet carrier 23a and annulus or ring 24a. The first annulus or ring 24a is rotationally solid with the outer hub 100. The first sun 21a is optionally connected to the shaft 7 via a one-way clutch K3. There may be two, three or more planets 22a.

The second epicyclic stage EP2 comprises second sun 21b, planets 22b, planet carrier 23b and annulus or ring 24b. The second annulus or ring 24b is connected to the first planet carrier 23a, and both are also connected to the axle 1 via a one-way clutch K2 that can be selectively activated and deactivated (i.e. allowed or disallowed to prevent rotation in one direction). The second sun 21b is connected for rotation with the outer hub 100. There may be two, three or more planets 22b.

The one-way clutch K2 may be selectively activated and deactivated in response to a sensed speed of angular rotation of the outer hub 100, which is proportional to the linear speed of travel of the bicycle 10. To this end, a speed sensor 31 is provided. This may act directly on the clutch K2, which responds passively to be activated or deactivated. For example, a governor type mechanism could be employed. A magnetic fluid could alternatively be employed to use the motion of the hub 100 to enable the clutch K2. Alternatively, a solenoid or other actuator 32 may respond to sensed speed to activate and deactivate the clutch K2, as described further below with reference to FIG. 6.

In use, pedal drive is transmitted to rear sprocket 80 that is connected to planet carrier 23b to drive it in rotation. Planet gears 22b transmit drive to sun gear 21b that rotates with outer hub 100. In summary, power input by a rider from the pedals 40 is transmitted to the planet carrier 23b via the sprocket 80 and thus to the outer hub 100 to drive the rear wheel 30. Electrical assistance from the rotor 6 is supplied via the sun 21a. The speed of the electric motor can be varied in relation to the hub speed to continuously alter the rider cadence, thereby EP1 and EP2 afford a continuously variable transmission (CVT). Examples of such CVTs are given in our WO publications mentioned above.

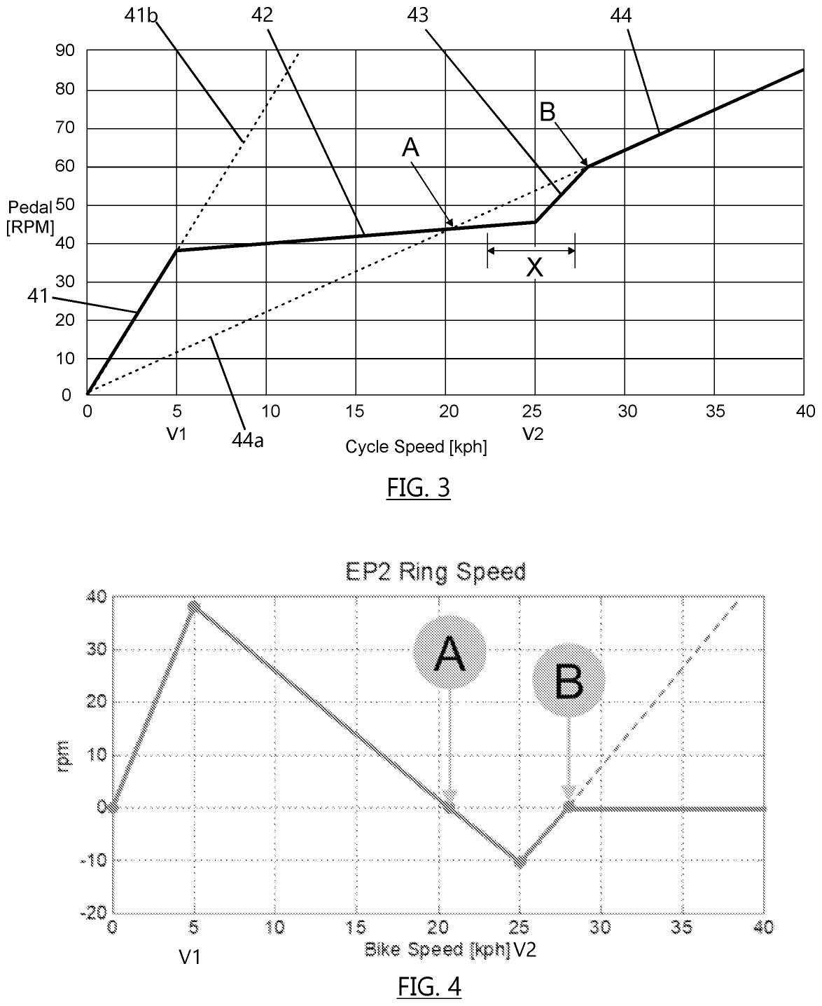

Before describing operation of the illustrated drive system, attention is directed to FIG. 3, in order to illustrate a potential problem of a CVT system and how the problem is solved by the illustrated example of the invention.

Firstly, it is to be noted that, in certain countries, the law requires that motor assistance is not allowed until a speed of 5 kph is reached. This condition is observed in the illustrated example.

In FIG. 3, drawn for an ebike with a wheel diameter of 700 mm, a line comprising four rectilinear portions 41, 42, 43 and 44 represents the behaviour of the illustrated drive system, showing the relationship between cadence (RPM) of pedals 40 and linear speed (kph) of bicycle 10. The behaviour changes at bicycle speeds V1 and V2 that, in this example, are 5 kph and 25 kph respectively but, in principle, could be any appropriate speeds.

At the origin (0,0) the rider begins to pedal and the bicycle begins to move. Up to speed V1, power is provided solely by the rider. This is represented by line portion 41 that, in this example, represents a lowest gear ratio of 1:1. If no electrical assistance were provided, the behaviour of the drive system would continue along line portion 41b, which is an extension of line portion 41.

However, at speed V1, with a pedal cadence of around 38 rpm, electrical assistance is introduced and the linear speed of the bicycle continues to increase up to speed V2, with little change in pedal cadence, as indicated by line portion 42, which is controlled by setting the speed of the electric motor 5,6. This allows setting the variation of cadence between speeds V and point B. In this example, at speed V2, the pedal cadence is around 45 rpm. In practice, the line portion 42 may be substantially straight and horizontal. The rider continues to pedal at around 40 rpm and, as long as pedalling continues with sufficient torque, the bicycle speed increases up to V2. Thus, line portion 42 indicates that the drive system is providing a continuously variable transmission (CVT) where the ratio between rider cadence and bike speed varies continuously.

At speed V2, electrical assistance diminishes and pedal cadence increases, as represented by line portion 43. At a speed of around 28 kph and a pedal cadence of around 58 rpm (in this example), electrical assistance ceases and any further increase in speed is effected by the rider continuing to pedal at an increased cadence, as indicated by line portion 44. The gradient of line portion 44 indicates a highest chain or belt ratio of around 50:14 (in this example). Line portion 44a indicates the same ratio, extrapolated back to the origin (0, 0).

It is to be appreciated that, if the behaviour of the drive system were not adapted to perform in a manner along the lines as illustrated in FIG. 3 (by way of example), the pedal cadence would have to increase at a dramatic rate in order to increase speed beyond V2, once the electrically assisted CVT dropped out at V2. In fact, it would be extremely difficult to increase speed beyond V2, by pedalling alone. With the motor 5,6 not powered, the cadence would be determined by line 41b.

There will now be described an example of how the drive system illustrated in FIG. 2 is operated to achieve operation as illustrated in FIG. 3. Firstly, there is a description of the bicycle 10 accelerating from rest.

### Mode 1: Pedal-Only Low Speed: Line Portion 41

From rest (0,0), the rider begins to pedal. One-way clutch K1 locks EP2 by preventing the EP2 carrier 23b from rotating forward, i.e. in the direction of pedalling motion, faster than the outer hub 100 and wheel 30. Thus EP2 ring 24b also rotates forward along with the outer hub 100 and wheel 30, and the bicycle 10 moves forward. As the rider pedals faster, the bicycle moves faster, up to speed V1 (5 kph).

By way of further explanation, EP2 clutch K1 forces hub 100 to rotate forward at the same speed as the sprocket 80, via inner hub 2. Therefore, traction goes through clutch K1. A secondary effect is that ring 24b and carrier 23a also rotate at the same speed as the sprocket 80. Therefore, in EP1, the ring 24a and carrier 23a also rotate at the speed of sprocket 80. Therefore sun 21a also rotates at the speed of sprocket 80.

### Transition to Mode 2: Pedelec (CVT)

As V1 is approached, rotor 6 starts to spin backwards and thereby disengages the EP2 clutch K1 at speed V1 by slowing down EP2 ring 24b.

### Mode 2: Pedelec (CVT): Line Portion 42

The motor 5,6 controls the pedal cadence, by regulating the speed of EP2 ring 24b. At a certain bicycle speed, and depending on the desired cadence, indicated by point A in FIG. 3, the EP2 ring 24b will be stationary and beyond that it will rotate backwards.

### Transition to Mode 3: Pedal Only-High Speed: Line Portions 42, 43

In the present example, this transition may be effected at speeds increasing between 22 and 27 kph, represented by points A and B in FIG. 3.

With the EP2 ring 24b rotating backwards, one-way clutch K2 is activated (enabled, not locked) to prevent the EP2 ring 24b, which is currently rotating backwards, from rotating forwards.

As the bicycle speed exceeds V2 (e.g. the legal limit), the motor 5,6 reduces or inverts its acceleration and the EP2 ring 24b, which is still rotating backwards, will slow down. When the motor speed is sufficiently reduced, the EP2 ring 24b will become stationary at point B in FIG. 3, where the one-way clutch K2 will stop it from rotating forwards. Therefore, beyond the bike speed of point B, the EP2 ring 24b remains stationary.

### Mode 3: Pedal Only-High Speed: Line Portion 44

With the one-way clutch K2 engaged, the rider can pedal unassisted at high speed, limited only by the rider's capabilities, at a gear ratio (wheel to pedal speed) of approximately 50:14 (in this example). The motor spins at a speed dictated by EP1 and EP2 with ring 24b stationary. The motor speed can be lower with clutch K3 in place.

There is now a description of the bicycle 10 decelerating to rest, from high speed, pedal-only operation.

### Mode 3: Pedal Only-High Speed: Line Portion 44

As the rider reduces pedalling torque and cadence, the bicycle speed reduces.

### Transition to Mode 2: Pedelec (CVT): Line Portions 43, 42

As the bicycle speed reduces, the motor 5,6 speeds up again to match the pedalling cadence of point B and engaging clutch K3. The one-way clutch K2 is disengaged as EP2 ring 24b starts to rotate backwards. If clutch K3 is omitted, the motor 5,6 is already operating at the right speed, so by applying power to the motor, the clutch K2 is unlocked.

### Mode 2: Pedelec (CVT): Line Portion 42

The motor 5,6 controls the pedal cadence, by regulating the speed of EP2 ring 24b.

With the bicycle speed reducing and EP2 ring 24b rotating backwards, the one-way clutch K2 is deactivated to allow EP2 ring 24b, which is currently rotating backwards, to start rotating forwards as point A is crossed.

The speed range within which clutch K2 is activated and deactivated is indicated by reference X. This range will lie within the speed interval between points A and B. The range X can be somewhat variable, depending upon configuration. It may be quite narrow if the clutch K2 is actively controlled (e.g. via solenoid 32), or wider if passively controlled (e.g. via a governor mechanism).

### Transition to Mode 1: Pedal-Only Low Speed: Line Portion 41

As bicycle speed reduces further, the motor 5,6 is depowered and the rotor 6 starts rotating forwards at the same speed as the outer hub 100, wheel 30 and EP2 planet carrier 22b, allowing the one-way clutch K1 to re-engage.

### Mode 1: Pedal-Only Low Speed: Line Portion 41

One-way clutch K1 locks EP2 by preventing the EP2 ring 24b from rotating faster than the outer hub 100 and wheel 30. Thus, EP2 ring 24b rotates forward along with the outer hub 100 and wheel 30, as the bicycle 10 moves forward. As the rider pedals slower and/or applies the brakes, the bicycle moves slower, and eventually comes to rest.

FIG. 4 shows the angular speed (rpm) of the EP2 ring 24b, against linear bicycle speed (kph). The ring 24b initially rotates forwards in synchronism with the pedal rpm of FIG. 3, from 0 rpm to V1. Thereafter, the speed of ring 24b decreases in a somewhat linear manner, from V1 to V2, to achieve the desired cadence variation with bike speed, going from a forwards direction to a backwards direction at point A. From V2, the negative speed of ring 24b decreases to zero at point B, where electrical assistance ceases. From point B, ring 24b is held stationary by clutch K2, as bicycle speed increases.

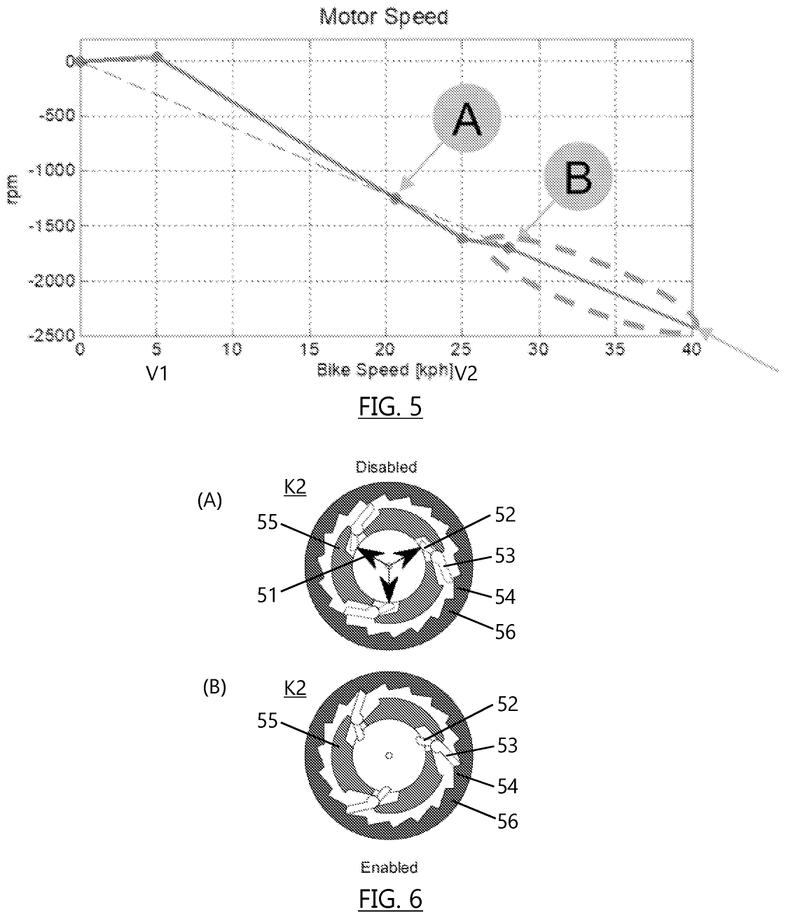

FIG. 5 shows the angular speed (rpm) of motor 5,6—that is, of rotor 6—against linear bicycle speed (kph). The rotor 6 initially rotates forwards at a slow speed, from 0 rpm to V1. Thereafter, the rotor speed increases linearly in a backwards (negative) direction, opposite to the direction of the pedal motion, from V1 to V2. From V2, the negative speed of rotor 6 increases more slowly to point B, where electrical assistance ceases. From point B, rotor 6 spins backwards at a steadily increasing speed as bicycle speed increases. This area is indicated in FIG. 5 by a chain-line ellipse, where the motor 5,6 can be operated in generator mode in order to achieve power regeneration. To this end, one-way clutch K3 is omitted and additional circuitry is required, to accommodate any regenerated power. If power regeneration is not required, then one-way clutch K3 remains in place. The purpose of clutch K3 is to prevent the rotor 6 from being driven and the motor 5,6 then going into generator mode.

A feature of the illustrated example is that the drive system allows the bicycle to be pushed backwards. To this end, the one-way clutch K1 locks EP2 such that the wheel 30 and outer hub 100 cause the EP2 ring 24b to rotate backwards, thereby spinning the rotor 6. The rotor 6 is allowed to spin, regardless of whether or not the clutch K2 is active and locked.

FIG. 6 shows one example of clutch K2.

In the upper view (A), the clutch K2 is deactivated (disabled). An actuator 51 acts upon levers 52 of pawls 53 that are mounted in an inner ring 55, such that the pawls 53 are out of engagement with teeth 54 in an outer ring 56.

In the lower view (B), the clutch K2 is activated (enabled). The actuator 51 is released from acting on the levers 52 and therefore the pawls 53 are free to pivot outwardly (e.g. under a resilient spring bias), to engage the teeth 54 in the outer ring 56. Thus, drive is provided between the inner ring 55 and the outer ring 56.

As indicated above, the actuator 51 may take various forms.

The illustrated configuration allows the bicycle 10 to be pushed in a walk-by-side mode. Whilst pushing, some motor assistance may be provided. For example, according to regulations in the EU, whilst pushing a pedelec, the person pushing the vehicle may use a walk-by-assist button to activate the motor to provide him/her with additional torque up to a bike speed of 6 km/h.

It is possible to adapt the illustrated example of the invention to allow the motor 5,6 to propel the bike without the need for the rider to pedal, i.e. to operate in ‘throttle mode’.

In the above description, the clutch K2 is activated between points A and B in the figures, and it then behaves like a one-way clutch. By providing an option also to lock the clutch K2 completely (two-ways), the motor 5,6 can then propel the bike directly—in throttle mode.

The clutch K2 may be selectively locked completely (two-ways) when the bike is stationary, under control of the rider. The rider can choose whether to ride in pedelec or throttle mode before setting off.

If the rider wishes to fully lock the clutch K2 to switch from pedelec to throttle mode while riding, the motor 5,6 will need to change speed, along with rider cadence, to bring EP2 ring 24b to a substantially stationary position, to allow clutch K2 to be fully locked without a significant jolt. The motor 5,6 can be suitably controlled by the controller 91, in response to a selected input by the rider. Depending on the bike speed at the time, this might require the rider to either increase pedal cadence (if to the right of point A in the figures) or decrease pedal cadence (if to the left of point A). The controller 91 may delay full locking of the clutch K2 until the speed of the motor 5,6 and pedal cadence of the rider are at or close to the desired levels to bring EP2 ring 24b to a substantially stationary position. The rider may be provided with audible and/or visible indications as to the need to increase or decrease pedal cadence.

Similarly, in order to selectively unlock the clutch K2 to switch from throttle to pedelec mode, it may be required to control the motor torque to bring the locking torque of clutch K2 to zero or close to it.

Although the line portions 42 and 43 are shown in FIG. 3 to be straight, they do not need to be, because the shape of line portions 42 and 43 is controlled by the electric motor 5,6.

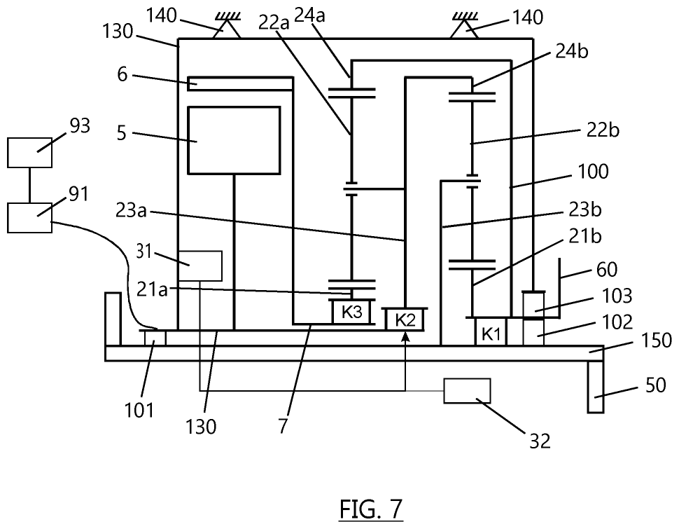

The drive system shown in FIG. 7 operates in a similar manner to the system of FIG. 2 and like references denote like or corresponding parts. However, the FIG. 7 variant is configured for use as a central or mid-drive location, around a crankshaft 150 connecting two pedal cranks 50.

Drive from pedals 40 is transmitted to planet carrier 23b which, in this case, is secured to shaft 150 that is driven in rotation with pedal cranks 50. Shaft 150 therefore provides the input, from pedals 40.

The stator 5 of motor 5, 6 is mounted to a housing 130 that is secured to a frame of the cycle at 140. The housing 130 has bearings 101 at one end, which engage with the shaft 150, and bearings 103 that engage at the other end with an output member 100 that is connected to annulus or ring gear 24a. The output member 100 is mounted on bearings 102 that engage the shaft 150. The output member 100 and the shaft 150 are rotatable about a common axis, which is the axis of rotation of the pedal cranks 50. The output member 100 is also connected to chain ring or wheel 60, from which drive is transmitted to a driven wheel, which would typically be a rear wheel 30 but could be a front wheel 20.

The rotor 6 of motor 5, 6 is mounted on shaft 7 that is mounted in turn on suitable bearings (not shown) for rotation with respect to the housing 130.

In use, input from the pedal cranks 50 is applied to planet carrier 23b. Motor drive is provided to sun gear 21a. Drive from output member 100 is transmitted to a driven wheel via chain ring or wheel 60 that connects to a drive sprocket on the driven wheel, typically via a freewheel mechanism. Whilst a chain drive is most common, other configurations such as belt drive or drive shaft are possible.

With like references denoting like or corresponding parts, including clutches K1, K2, K3, it will be understood that the drive system shown in FIG. 7 operates in a similar manner to the system of FIG. 2 as explained in the foregoing description, particularly with reference to FIGS. 3 to 6. The above description with reference to FIGS. 2 to 6 applies also to the example of FIG. 7, apart from the noted differences in configuration.

In the FIG. 7 configuration, the gear ratio of the epicyclic gear set may be different to that in a rear drive configuration.

The above-described and illustrated examples of the invention may provide drive systems for electrically-assisted pedal cycles that are effective whilst being relatively light and compact and, in particular, allow the rider the convenience of CVT operation up to a predetermined speed, after which the rider can continue to increase speed by pedalling, without electrical assistance and with a practical and effective gear ratio between pedal and wheel.

In principle, V1 and V2 can have any reasonable values, though often may be dictated by local laws. V1 could be zero, where there is no legal minimum speed for electrical assistance.

Whilst examples of motors and drive trains have been illustrated and described, other embodiments of the invention may have different configurations of motors and drive trains.

In this specification, the verb “comprise” has its normal dictionary meaning, to denote non-exclusive inclusion. That is, use of the word “comprise” (or any of its derivatives) to include one feature or more, does not exclude the possibility of also including further features. The word “preferable” (or any of its derivatives) indicates one feature or more that is preferred but not essential.

The reader's attention is directed to all and any priority documents identified in connection with this application and to all and any papers and documents which are filed concurrently with or previous to this specification in connection with this application and which are open to public inspection with this specification, and the contents of all such papers and documents are incorporated herein by reference.

All or any of the features disclosed in this specification (including any accompanying claims, abstract and drawings), and/or all or any of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1-30. (canceled)

31. A drive system for an electrically-assisted pedal cycle, the system comprising:
an input that, in use, receives drive from a pedal of the cycle and rotates about an axis;
an output that, in use, rotates about said axis to provide drive to a driven wheel of the cycle;
an electrical machine that, in use, provides motor drive to said output; and
a drive train that, in use, provides a mechanical drive connection between the electrical machine, said input, and said output;
wherein:
between cycle speeds of 0 and V1, where V1>0, the drive train provides output drive only from said pedal, through the drive train, without drive from the electrical machine, at a first and lowest gear ratio between said input and output;
between cycle speeds of V1 and V2, where V2 is greater than V1, the drive train provides a continually variable transmission (CVT) by the electrical machine provides drive assistance and controls a pedal cadence; and
above a cycle speed of V2, the drive train provides output drive only from said pedal, through the drive train, without drive from the electrical machine, and with a second gear ratio that is higher than said first gear ratio.

32. The drive system of claim 31, wherein the drive train comprises an epicyclic gear set having a first input connected to the electrical machine and a second input connected to the pedal.

33. The drive system of claim 32, wherein the epicyclic gear set is a dual epicyclic gear set having first and second stages that are interconnected, the first stage comprising a first sun, first planets, and first annulus and the second stage comprising a second sun, second planets, and second annulus.

34. The drive system of claim 33, wherein the electrical machine has a rotor connected to drive the first sun.

35. The drive system of claim 33, wherein drive from the pedal is connected to drive the second planet carrier.

36. The drive system of claim 33, wherein the first annulus is connected to rotate with said output.

37. The drive system of claim 33, wherein the second sun is connected to rotate with said output.

38. The drive system of claim 33, wherein the second annulus is connected to rotate with the first planet carrier.

39. The drive system of claim 31, wherein a first, one-way clutch is connected between the input and said output, to prevent the input from rotating faster than said output.

40. The drive system of claim 31, wherein a second clutch is connected between a moveable part of the drive train and a fixed part of the drive system or respective cycle, and an actuator for the second clutch activates the second clutch to operate in a one-way mode.

41. The drive system of claim 40, wherein said actuator responds to an angular speed of said output.

42. The drive system of claim 40, wherein said actuator is electrically operated.

43. The drive system of claim 40, wherein said actuator is selectively operable to cause the second clutch to lock the second planet carrier to said fixed part.

44. The drive system of claim 40, wherein the drive train comprises an epicyclic gear set having a first input connected to the electrical machine and a second input connected to the pedal, the epicyclic gear set being a dual epicyclic gear set having first and second stages that are interconnected, the first stage comprising a first sun, first planets, and first annulus and the second stage comprising a second sun, second planets and second annulus, and wherein said moveable part of the drive train is the second annulus.

45. The drive system of claim 31, wherein a third, one-way clutch is connected between the electrical machine and the drive train.

46. The drive system of claim 31, wherein V1=5 kph.

47. The drive system of claim 31, wherein V2=25 kph.

48. The drive system of claim 31, wherein there is a transition range (A,B) around cycle speed V2, in which range a changeover is effected between drive assistance from the electrical machine and output drive only from the pedal.

49. An electrically-assisted pedal cycle having the drive system of claim 31.

50. The electrically-assisted pedal cycle of claim 49, being a pedelec in which electrical assistance is provided only when a cyclist is pedalling.

51. The electrically-assisted pedal cycle of claim 49, in which electrical assistance is available both when a cyclist is pedalling and also when the cyclist is not pedalling.

52. The electrically-assisted pedal cycle of claim 51, having a throttle control by which a cyclist can apply or superimpose a desired amount of electrical assistance.

53. The electrically-assisted pedal cycle of claim 49, wherein the drive train is located within a hub of the driven wheel.

54. The electrically-assisted pedal cycle of claim 49, wherein the drive train is located around or adjacent a crankshaft connecting two pedal cranks.

55. A method of operating the electrically-assisted pedal cycle of claim 49, comprising the steps of providing motor drive to the driven wheel of the cycle by said electrical machine and providing pedal drive to the driven wheel of the cycle, via said drive train.
